(19) United States
(12) Patent Application Publication
(10) Pub. No.: US 2026/0333283 A1
(43) Pub. Date: Oct. 22, 2026

(54) NUMBER OF SAMPLES CONSIDERATIONS FOR THE MEASUREMENT PERIOD FOR SL POSITIONING

(71) Applicant: QUALCOMM Incorporated, San Diego, CA (US)

(72) Inventors: Alexandros MANOLAKOS, Athens (GR); Carlos CABRERA MERCADER, Cardiff, CA (US); Gabi SARKIS, San Diego, CA (US); Sony AKKARAKARAN, Poway, CA (US); Sven FISCHER, Nuremberg (DE)

(21) Appl. No.: 19/486,233

(22) PCT Filed: Jul. 1, 2024
(86) PCT No.: PCT/US2024/036405

§ 371 Date: Nov. 20, 2025

(30) Foreign Application Priority Data
Jul. 27, 2023 (GR) 20230100625

(51) Int. Cl. H04W 64/00; H04L 5/00; H04W 24/08; H04W 92/18

(52) U.S. Cl. CPC H04W 64/00; H04L 5/0051; H04W 24/08; H04W 92/18

(57) ABSTRACT

Apparatus, methods, and computer program products for sidelink positioning are provided. An example method may include receiving a set of sidelink control information (SCI), where the set of SCI reserves a set of resources for transmission of a set of sidelink positioning reference signals (SL-PRSs) in at least one same slot, where the set of resources are periodic. The example method may further include measuring the set of SL-PRSs within a measurement period based on the set of SCI satisfying at least one condition in a set of conditions.

### CROSS-REFERENCE TO RELATED APPLICATION

This application claims the benefit of Greek Patent Application Serial No. 20230100625, entitled “NUMBER OF SAMPLES CONSIDERATIONS FOR THE MEASUREMENT PERIOD FOR SL POSITIONING” and filed on Jul. 27, 2023, which is expressly incorporated by reference herein in its entirety.

### TECHNICAL FIELD

The present disclosure relates generally to communication systems, and more particularly, to wireless communication systems with sidelink positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to receive a set of sidelink control information (SCI), where the set of SCI reserves a set of resources for transmission of a set of sidelink positioning reference signals (SL-PRSs) in at least one same slot, where the set of resources are periodic. Based at least in part on information stored in the at least one memory, the at least one processor, individually or in any combination, is configured to measure the set of SL-PRSs within a measurement period based on the set of SCI satisfying at least one condition in a set of conditions.

In another aspect of the disclosure, a method, a computer-readable medium, and an apparatus at a UE are provided. The apparatus may include at least one memory and at least one processor coupled to the at least one memory. Based at least in part on information stored in the at least one memory, the at least one processor, individually or in any combination, is configured to receive SCI, where the SCI reserves one or more SL-PRS resources for transmission of at least one sidelink positioning reference signal (SL-PRS). Based at least in part on information stored in the at least one memory, the at least one processor, individually or in any combination, is configured to measure the at least one SL-PRS in a measurement period.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2 illustrates example aspects of a sidelink (SL) slot structure.

FIG. 3 is a diagram illustrating an example of a first device and second device in an access network, in accordance with various aspects of the present disclosure.

FIG. 4 is a diagram illustrating an example of a UE positioning based on reference signal measurements.

FIG. 5 illustrates examples of resource reservation for sidelink communication.

FIG. 6 is a diagram illustrating example sidelink slot structure, in accordance with various aspects of the present disclosure.

FIG. 7 is a diagram illustrating an example of SL-PRS configuration and resource pool (RP) for positioning (RP-P) configuration.

FIG. 8 is a diagram illustrating example measurement period.

FIG. 9 is a diagram illustrating example periodic reservations.

FIG. 10 is a diagram illustrating example SCI reserving resources for multiple transmissions.

FIG. 11 is a diagram illustrating example communications between two UEs.

FIG. 12 is a diagram illustrating example SL-PRS and associated periodic reservations.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a diagram illustrating an example of a hardware implementation for an example apparatus and/or network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

For SL-PRS transmissions, SL-PRS transmissions with periodic reservation and SL-PRS transmissions without periodic reservation may be supported. SL-PRS transmissions with periodic reservation may be SL-PRS transmissions that are being reserved based on SL periodic resource reservation. SL-PRS transmissions without periodic reservation may be SL-PRS transmissions in which the SL-PRS is transmitted at least once without periodic reservation. Aspects provided herein provide mechanisms for defining measurement periods for both SL-PRS transmissions with periodic reservation and SL-PRS transmissions without periodic reservation, facilitating sidelink positioning.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

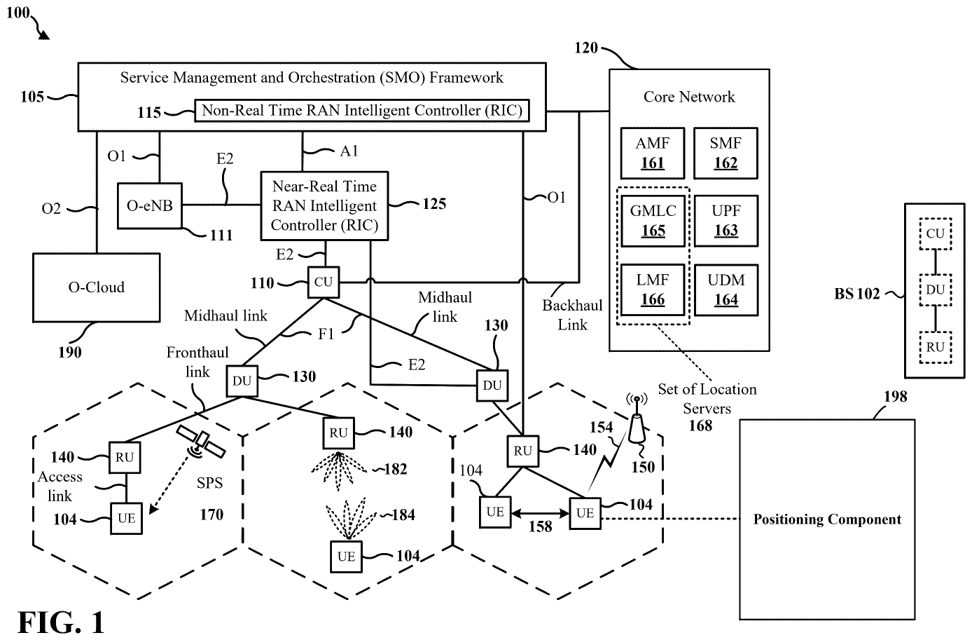

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/IL models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

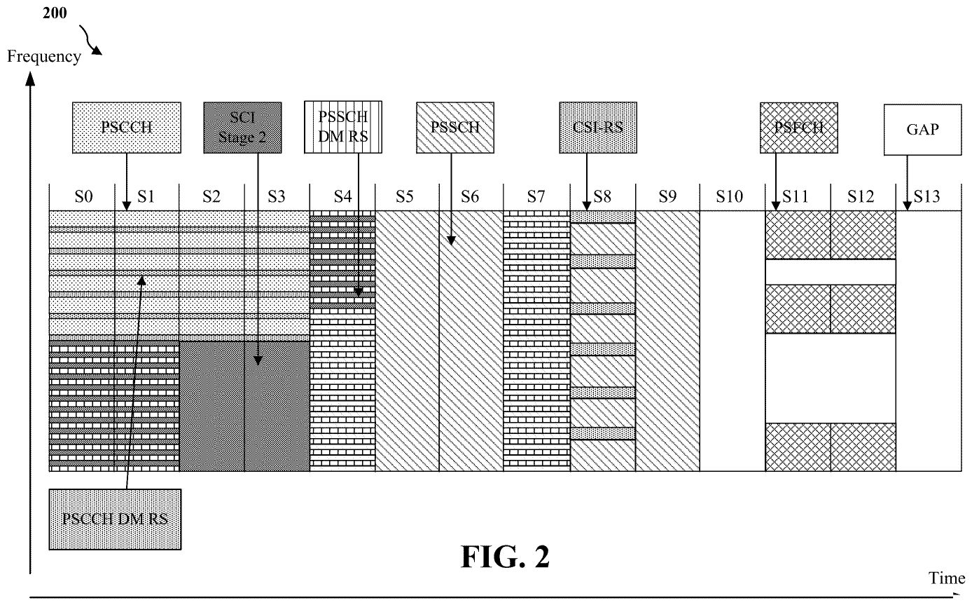

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications (e.g., including cellular V2X (CV2X)). Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 2, in some aspects. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a positioning component 198. In some aspects, the positioning component 198 may be configured to receive a set of sidelink control information (SCI), where the set of SCI reserves a set of resources for transmission of a set of sidelink positioning reference signals (SL-PRSs) in at least one same slot, where the set of resources are periodic. In some aspects, the positioning component 198 may be further configured to measure the set of SL-PRSs within a measurement period based on the set of SCI satisfying at least one condition in a set of conditions. In some aspects, the positioning component 198 may be further configured to receive sidelink control information (SCI), where the SCI reserves one or more SL-PRS resources for transmission of at least one sidelink positioning reference signal (SL-PRS). In some aspects, the positioning component 198 may be further configured to measure the at least one SL-PRS in a measurement period.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

FIG. 2 includes diagram 200 illustrating example aspects of slot structures that may be used for sidelink communication (e.g., between UEs 104, a RSU, or the like). The slot structure may be within, or may use aspects of, a 5G/NR frame structure in some examples. As an example, NR CV2X may be based on an NR frame structure. In other examples, the slot structure may be within an LTE frame structure. As an example, LTE based CV2X may use an LTE frame structure in some aspects. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates an example sidelink transmission. A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The physical sidelink shared channel (PSSCH) occupies at least one subchannel. In some aspects, the PSCCH may include a first portion of sidelink control information (SCI) that may be referred to as SCI-1, and the PSSCH may include a second portion of SCI that may be referred to as SCI-2. The SCI may indicate information for a receiver to receive a data transmission in PSSCH. In some aspects, the SCI may indicate the resources on which the PSSCH will be transmitted. In such aspects, the SCI may be referred to as including a resource reservation.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DM-RS). There may be a 1:4 ratio between PSCCH and DM-RS associated with the PSCCH. There may be a 1:2 ratio between PSSCH and DM-RS associated with the PSSCH. At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DM-RS, SCI, feedback, gap symbols, and/or LBT symbols may be different than the example illustrated in FIG. 2. Multiple slots may be aggregated together in some aspects.

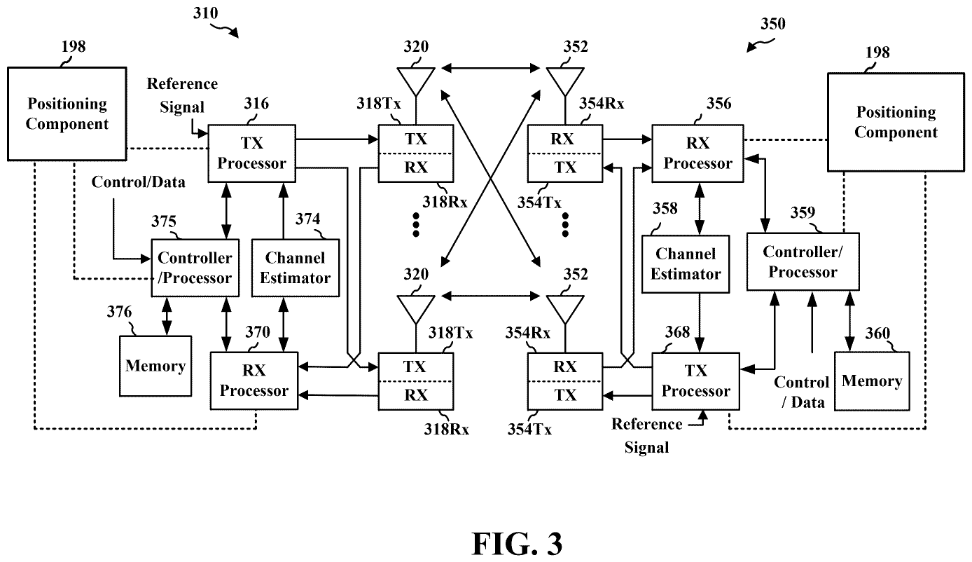

FIG. 3 is a block diagram of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and the 350 may include a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318Tx. Each transmitter 318Tx may modulate an RF carrier with a respective spatial stream for transmission.

At the device 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The transmission is processed at the device 310 in a manner similar to that described in connection with the receiver function at the device 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, and the controller/processor 359 may be configured to perform aspects in connection with positioning component 198 of FIG. 1.

At least one of the TX processor 316, the RX processor 370, and the controller/processor 375 may be configured to perform aspects in connection with positioning component 198 of FIG. 1.

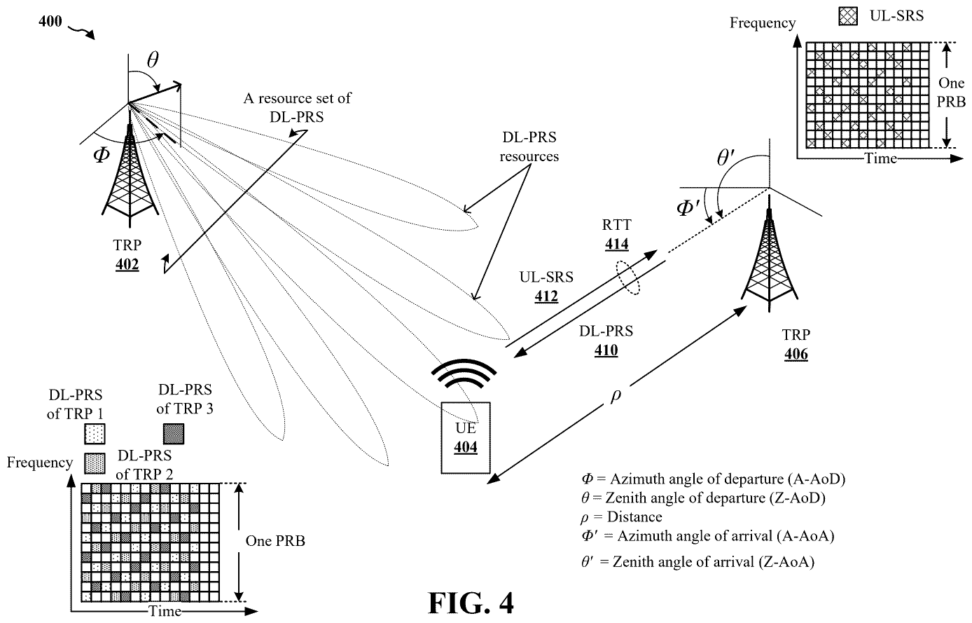

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s)168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Sidelink communication may be based on different types or modes of resource allocation mechanisms. In a first resource allocation mode (which may be referred to herein as “Mode 1”), centralized resource allocation may be provided by a network entity. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots.

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation Mode 2, the UE may determine (e.g., sense) whether a selected sidelink resource has been reserved by other UE(s) before selecting the sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field included in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

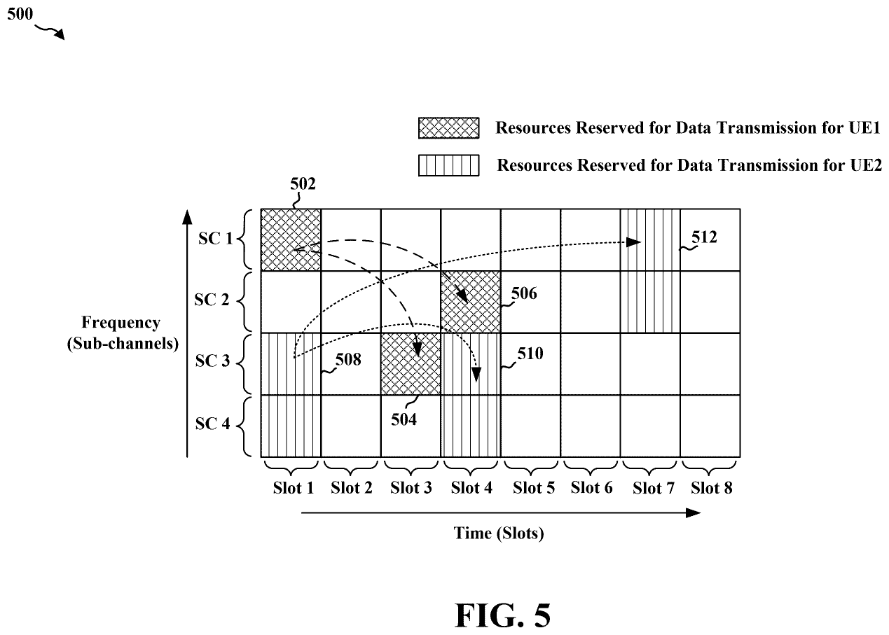

FIG. 5 is an example 500 of time and frequency resources showing reservations for sidelink transmissions, as presented herein. The resources may be included in a sidelink resource pool, for example. The resource allocation for each UE may be in units of one or more sub-channels in the frequency domain (e.g., sub-channels SC1 to SC 4), and may be based on one slot in the time domain (e.g., slots “1” to 8). The UE may also use resources in the current slot to perform an initial transmission, and may reserve resources in future slots for retransmissions. In the illustrated example of FIG. 5, two different future slots are being reserved by UE1 and UE2 for retransmissions. The resource reservation may be limited to a window of a pre-defined slots and sub-channels, such as an 8 time slots by 4 sub-channels window as shown in example 500, which provides 32 available resource blocks in total. This window may also be referred to as a resource selection window.

A first UE (“UE1) may reserve a sub-channel (e.g., SC 1) in a current slot (e.g., slot 1) for its initial data transmission 502, and may reserve additional future slots within the window for data retransmissions (e.g., a first data retransmission 504 and a second data retransmission 506). For example, the first UE may reserve sub-channels SC 3 at slot 3 and SC 2 at slot 4 for future retransmissions as shown by FIG. 5. The first UE then transmits information regarding which resources are being used and/or reserved by it to other UE(s). The first ULE may do so by including the reservation information in a reservation resource field of the SCI, e.g., a first stage SCI (SCI 1). There may be a second stage SCI (SCI 2). As one example, the SCI 2 may be mapped to contiguous RBs in a PSSCH starting from the first symbol associated with PSSCH DM-RS. A format of the SCI 2 may be indicated in the first stage SCI. The SCI 1 may be transmitted in a PSCCH. A number of resource elements (REs) may be derived based on the SCI 1. A starting location of the SCI 2 may be defined and known to a UE. In some aspects, a UE may not blindly decode SCI 2. An SCI 2 format may include one or more of a HARQ process identifier (ID), a new data indicator (NDI), a source ID, a destination ID, a CSI report trigger, or the like. An SCI 2 format associated with a groupcast may also include a zone ID indicating a location of a transmitter and a communication range for sending feedback. An SCI 1 for dedicated resource pool (RP) may be used for the scheduling of SL-PRS. The SCI 1 for scheduling of SL-PRS may be of format SCI 1-B and may include information regarding: priority, source identifier (ID), destination ID, cast type indicator indicating cast type (e.g., unicast, broadcast, or multicast), resource reservation period, SL-PRS request, or the like. With regards to the SL-PRS configuration and/or SL-PRS time assignment information, in some aspects, there may be a one-to-one mapping relationship between a PSCCH resource and an associated SL-PRS resource in the same slot and there may be no explicit signaling of which SL PRS resource for the same slot. There may also be a same quantity of PSCCH resource(s) and SL-PRS resource(s). In some aspects, there may be an explicit signaling of SL PRS resource in the same slot. In some aspects, there may be a mapping relationship between a PSCCH resource and one or more associated SL-PRS resource(s) in the same slot and explicit signaling of SL PRS resource. In some aspects, there may be a one-to-one mapping is used between a PSCCH resource and an associated SL-PRS resource in the same slot if explicit signalling is not used. With a one-to-one mapping, some SL-PRS resources might not be mapped.

FIG. 5 illustrates that a second UE (“UE2”) reserves resources in sub-channels SC 3 and SC 4 at slot “1” for a current data transmission 508, reserves a first data retransmission 510 at slot 4 using sub-channels SC 3 and SC 4, and reserves a second data retransmission 512 at slot 7 using sub-channels SC “1” and SC 2, as shown by FIG. 5. Similarly, the second UE may transmit the resource usage and reservation information to other UE(s), such as using the reservation resource field in SCI.

A third UE may consider resources reserved by other UEs within the resource selection window to select resources to transmit its data. The third UE may first decode SCIs within a time period to identify which resources are available (e.g., candidate resources). For example, the third UE may exclude the resources reserved by UE1 and UE2 and may select other available sub-channels and time slots from the candidate resources for its transmission and retransmissions, which may be based on a number of adjacent sub-channels in which the data (e.g., packet) to be transmitted can fit.

While FIG. 5 illustrates resources being reserved for an initial transmission and two retransmissions, the reservation may be for an initial transmission and a single transmission or just for an initial transmission.

The UE may determine an associated signal measurement (such as RSRP) for each resource reservation received by another UE. The UE may consider resources reserved in a transmission for which the UE measures an RSRP below a threshold to be available for use by the UE. A UE may perform signal/channel measurement for a sidelink resource that has been reserved and/or used by other UE(s), such as by measuring the RSRP of the message (e.g., the SCI) that reserves the sidelink resource. Based at least in part on the signal/channel measurement, the UE may consider using/reusing the sidelink resource that has been reserved by other UE(s). For example, the UE may exclude the reserved resources from a candidate resource set if the measured RSRP meets or exceeds the threshold, and the UE may consider a reserved resource to be available if the measured RSRP for the message reserving the resource is below the threshold. The UE may include the resources in the candidate resources set and may use/reuse such reserved resources when the message reserving the resources has an RSRP below the threshold, because the low RSRP indicates that the other UE is distant and a reuse of the resources is less likely to cause interference to that UE. A higher RSRP indicates that the transmitting UE that reserved the resources is potentially closer to the UE and may experience higher levels of interference if the UE selected the same resources.

For example, the UE may determine a set of candidate resources (e.g., by monitoring SCI from other UEs and removing resources from the set of candidate resources that are reserved by other UEs in a signal for which the UE measures an RSRP above a threshold value). The UE may also select N resources for transmissions and/or retransmissions of a TB. As an example, the UE may randomly select the N resources from the set of candidate resources previously determined. For each transmission, the UE may reserve future time and frequency resources for an initial transmission and up to two retransmissions. The UE may reserve the resources by transmitting SCI indicating the resource reservation. For example, in the example in FIG. 5, the second UE may transmit SCI reserving resources for the current data transmission 508, the first data retransmission 510, and the second data retransmission 512.

There may be a timeline for a sensing-based resource selection. For example, the UE may sense and decode the SCI received from other UEs during a sensing window, e.g., a time duration prior to resource selection. Based on the sensing history during the sensing window, the UE may be able to maintain a set of available candidate resources by excluding resources that are reserved by other UEs from the set of candidate resources. A UE may select resources from its set of available candidate resources and transmits SCI reserving the selected resources for sidelink transmission (e.g., a PSSCH transmission) by the UE. There may be a time gap between the UE's selection of the resources and the UE transmitting SCI reserving the resources.

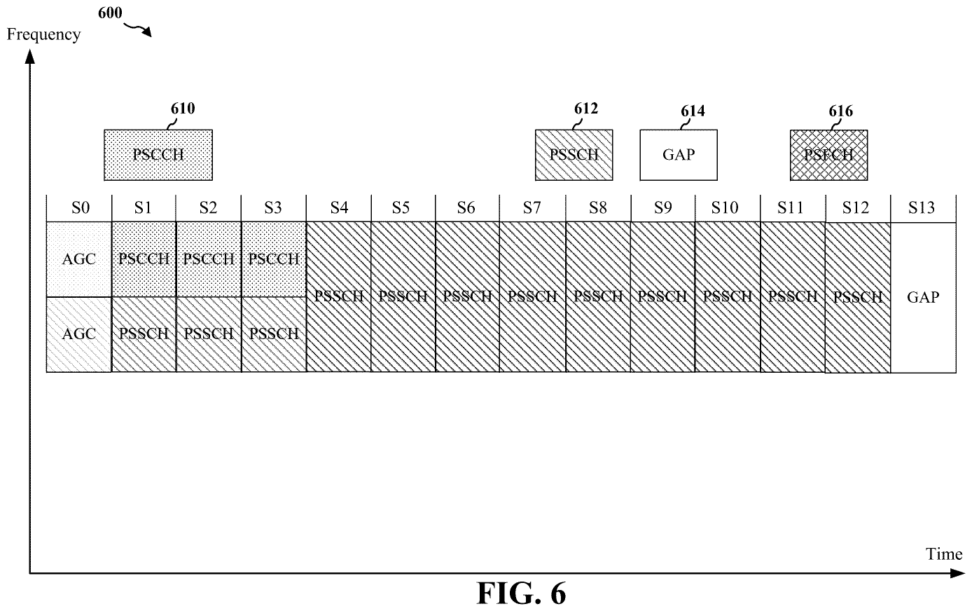

FIG. 6 is a diagram 600 illustrating example sidelink slot structure, in accordance with various aspects of the present disclosure. As illustrated in FIG. 6, a slot may include 14 OFDM symbols and the first symbol may be repeated on the preceding symbol for automatic gain control (AGC). A gap symbol 614 may be present after PSSCH 612. A PSCCH 610 and a PSSCH 612 may be transmitted on a same slot. The PSCCH may carry SCI 1 and the SCI 1 may include resource allocation information as well as other fields for receiving the sidelink shared channel PSSCH transmission. FIG. 6 also shows PSFCH 616.

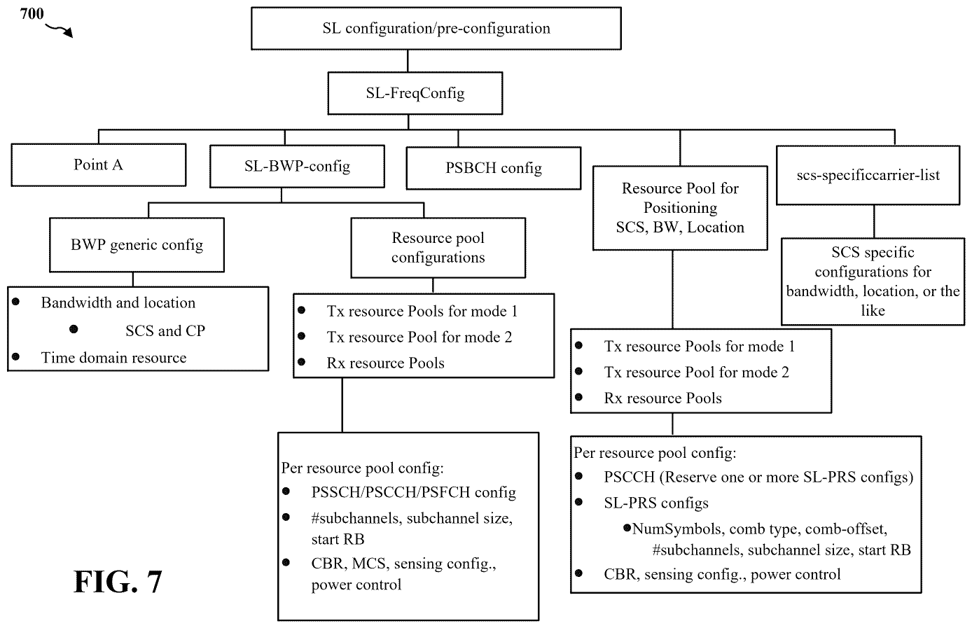

FIG. 7 is a diagram 700 illustrating an example of sidelink positioning reference signal (PRS) configuration and resource pool (RP) for positioning (RP-P) configuration. As illustrated in FIG. 7, in some wireless communication systems, a sidelink communication configuration (such as a sidelink positioning configuration, a sidelink data configuration, or a configuration used jointly for data and positioning) may include a SL frequency configuration and may be associated with a Point A (which may be a common reference point for resource block grids and may be represented by a frequency offset between Point A and a lowest subcarrier of the lowest resource block of the SS/PBCH block used by the UE for initial cell selection or an absolute frequency), a SL bandwidth part (BWP) configuration, a PSBCH configuration, a resource pool for positioning, SCS, BW, location, or the like, or a SCS carrier list. The SCS carrier list may be associated with SCS specific configurations for bandwidth, location, or the like.

In some aspects, The SL BWP configuration may be associated with Tx resource pools for mode 1 (mode A), Tx resource pools for mode 2 (mode B), and Rx resource pools. In some aspects, per resource pool configurations may be provided. The per resource pool configurations may include PSSCH/PSCCH/PSFCH configurations, subchannel number, size, or starting RB, and channel busy ratio (CBR), modulation and coding scheme (MCS), sensing configuration, or power control configurations.

In some aspects, the resource pool for positioning, SCS, BW, location, or the like may be associated with Tx resource pools for mode 1 (mode A), Tx resource pools for mode 2 (mode B), and Rx resource pools. In some aspects, per resource pool configurations may be provided. The per resource pool configurations may include PSCCH or SL-PRS configurations (e.g., including number of symbols, comb type, comb offset, number of subchannels, subchannel size, subchannel starting RB, or the like), CBR, MCS, sensing configuration, or power control configurations.

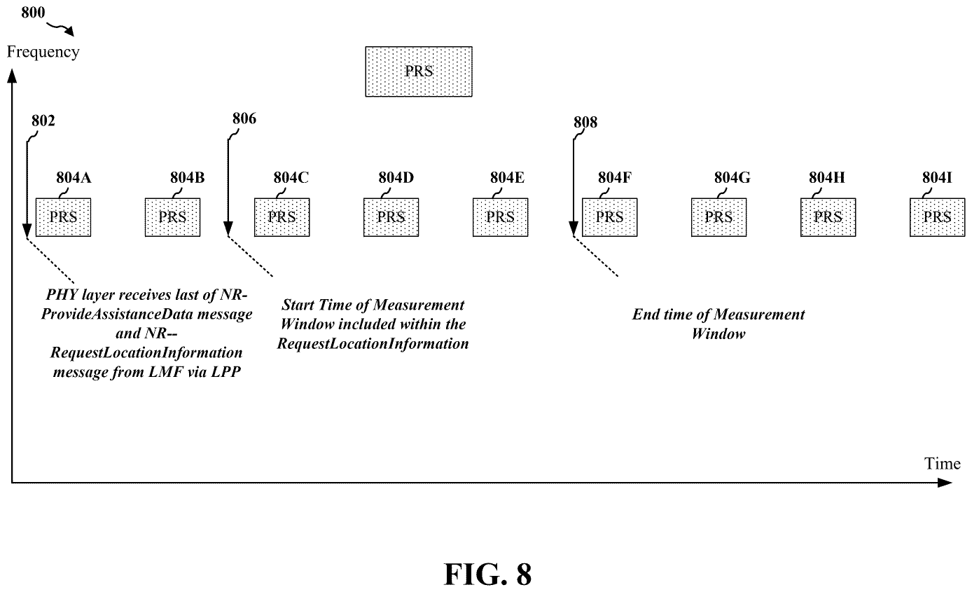

FIG. 8 is a diagram 800 illustrating example measurement period. As illustrated in FIG. 8, at 802, when PHY layer of a UE receives a message providing data related to positioning or triggers positioning, such as a Multi-RTT-ProvideAssistanceData message that provides assistance data for multi-RTT positioning or a Multi-RTT-RequestLocationInformation message that requests multi-RTT measurements, the UE may measure multiple (e.g., based on the UE capability) UE Rx-Tx time difference measurements in positioning frequency layers configured for the UE within a measurement period (e.g., in time) that may be T_{UERxTx,Total} ms. The term “measurement period” may refer to a time period where the UE may perform measurements for positioning based on a message that triggers the measurements. As illustrated in FIG. 8, there may be multiple PRSs (e.g., that may be periodically transmitted) including PRS 804A, PRS 804B, PRS 804C, PRS 804D, PRS 804E, PRS 804F, PRS 804G, PRS 804H, and PRS 804I. A start time 806 of measurement window may be included in the message that provides data related to positioning or triggers positioning, such as the Multi-RTT-RequestLocationInformation message. The end time 808 of measurement window may be based on capability of the UE. The measurement period T_{UERxTx,i} may start from the first measurement gap (MG) instance aligned with DL PRS resources of positioning frequency layer i closest in time after both the Multi-RTT-RequestLocationInformation message and Multi-RTT-ProvideAssistanceData message from LMF via a positioning protocol are delivered to the PHY layer of UE.

In some wireless communication systems, a UE may measure at least four samples before reporting the measurements back to the network. For example, a parameter T_{PRS-RSTD,i} may represent the measurement period for PRS RSTD measurement in PRS frequency layer i, and specified as:

$${T}_{PRS - RSTD , i} = ( {CSSF}_{PRS , i} * {N}_{RxBeam , i} * ⌈ \frac{{N}_{PRS , i}^{slot}}{{N}^{′}} ⌉ ⌈ \frac{{L}_{PRS , i}}{N} ⌉ * {N}_{sample} - 1 ) * {T}_{effect , i} + {T}_{last} .$$

The parameter N_{RxBeam,i} is the UE Rx beam sweeping factor, which may be based on the frequency range that the UE is operating in. For example, the UE Rx beam sweeping factor may be 1 for FR1 and may be 8 for FR2. The parameter CSSF_{PRS,i} is the carrier-specific scaling factor for NR PRS-based positioning measurements in frequency layer i. The parameter Nₛₐₘₚₗₑ is the quantity of PRS RSTD samples and Nₛₐₘₚₗₑ may equal to four. The total measurement period may be represented by T_{RSTD,Total}, and as an example,

$${T}_{RSTD , Total} = {\sum }_{i = 1}^{L} {T}_{RSTD , i} + ( L - 1 ) * max ( {T}_{effect , i} ) .$$

The parameter i is the index of positioning frequency layer, the parameter L is total number of positioning frequency layers, and the parameter T_{effect,i} is the periodicity of the PRS RSTD measurement in positioning frequency layer i. The parameter T_{RSTD,i} represents the measurement period for PRS RSTD measurement in positioning frequency layer i, which may be specified as:

$${T}_{RSTD , i} = ( {CSSF}_{PRS , i} * {N}_{RxBeam , i} * ⌈ \frac{{N}_{PRS , i}^{slot}}{{N}^{′}} ⌉ ⌈ \frac{{L}_{available \_ PRS , i}}{N} ⌉ * {N}_{sample} - 1 ) * {T}_{effect , i} + {T}_{last , i} .$$

The parameter N_{RxBeam,i} is the UE Rx beam sweeping factor. The parameter CSSF_{PRS,i} is the carrier-specific scaling factor for NR PRS-based positioning measurements in frequency layer i. The parameter

$${N}_{PRS , i}^{slot}$$

is the maximum number of DL PRS resources in positioning frequency layer i configured in a slot. The parameter N′ is UE capability for number of DL PRS resources that it can process in a slot as indicated by an information element (e.g., maxNumOfDL-PRS-ResProcessedPerSlot). The parameter L_{available_PRS,i} is the time duration of available PRS in the positioning frequency layer i to be measured during T_{available_PRS,i}, and is calculated in the same way as PRS duration K. The PRS resources that are unmuted and fully or partially overlapped with MG may be considered for the calculation of the parameter L_{available_PRS,i}. The parameter Nₛₐₘₚₗₑ is the number of PRS RSTD samples. The parameter T_{last,i} is the measurement duration for the last PRS RSTD sample in positioning frequency layer i, including the sampling time and processing time. The T_{last,i} may equal to Tᵢ+T_{available_PRS,i}. The parameter Tᵢ corresponds to a duration of PRS processing symbol in every T ms, which may be indicated by an information element durationOfPRS-ProcessingSymbolsInEveryTms. The parameter T_{effect,i} may be equal to

$$⌈ \frac{{T}_{i}}{{T}_{available \_ PRS , i}} ⌉ * {T}_{available \_ PRS , i} .$$

Example of T may include 8, 16, 20, 30, 40, 80, 160, 320, 640, 1280, or the like. The parameter T_{available_PRS,i}=LCM(T_{PRS,i},MGRPᵢ), which may be the least common multiple between T_{PRS,i} and MGRPᵢ may be the repetition periodicity of the measurement gap applicable for measurement in the PRS frequency layer i. The parameter T_{PRS,i} is the periodicity of DL PRS resource with muting on positioning frequency layer i. In some aspects, if the MG pattern is reconfigured during the measurement period of one or more positioning frequency layers, the measurement period may be extended.

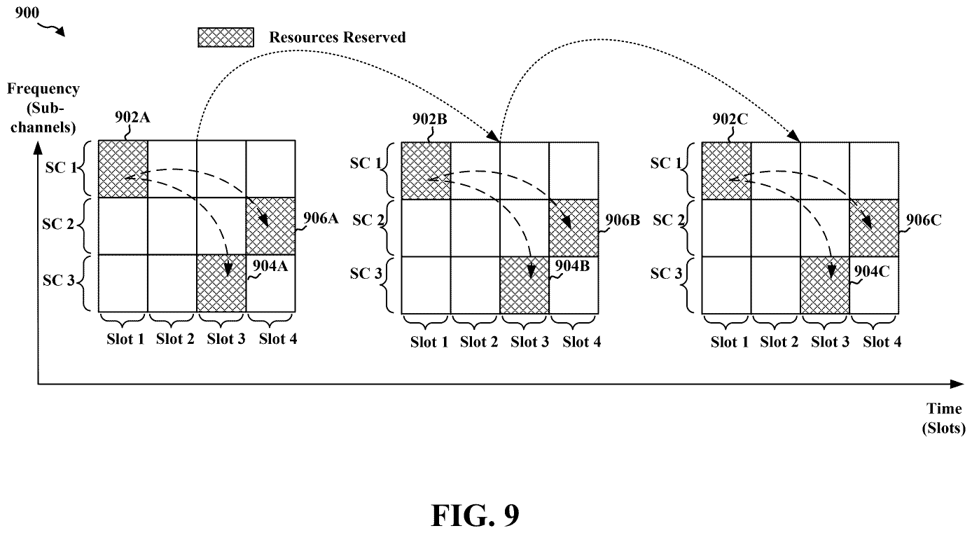

A SL transmission may reserve resources in the current slot and in a number of (e.g., two) future slots. The SL transmission that may reserve resources may be SCI and reservations may be in a window of a certain number (such as 32) of logical slots. In some aspects, as described in connection with FIG. 5, aperiodic reservations may be supported. In some aspects, periodic reservations may be supported. In some aspects, a period, with a configurable value, may be signaled in SCI. Periodic resource reservation and signaling may be enabled or disabled based on a configuration. FIG. 9 is a diagram 900 illustrating example periodic reservations. As illustrated in FIG. 9, resources may be reserved for an initial transmission 902A, subsequent transmission 904A, and a subsequent transmission 906A in a first window. Resources may also be reserved for a first transmission 902B, a subsequent transmission 904B, and a subsequent transmission 906B in a second window. Resources may also be reserved for a first transmission 902C, a subsequent transmission 904C, and a subsequent transmission 906C in a third window. The time between the windows may be based on the period with the configurable value.

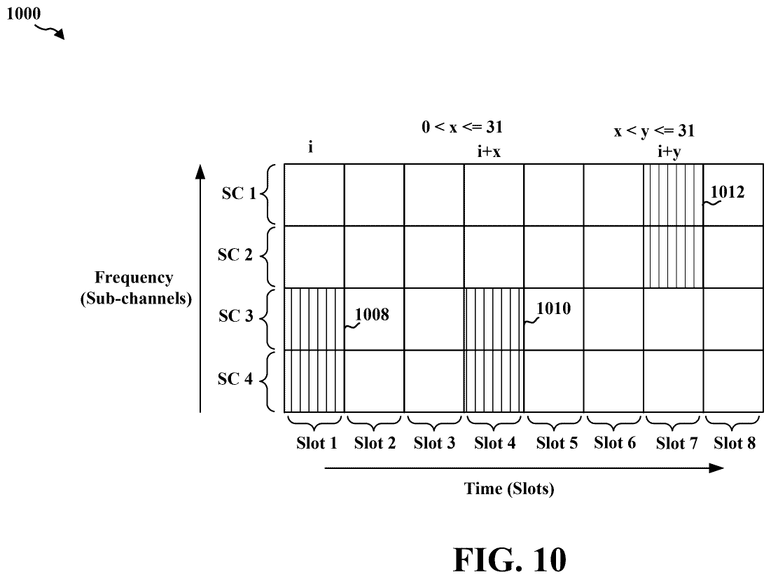

In some aspects, SCI may reserve resources for one, two, or three transmissions. The maximum number of reservations allowed may be configured. In some aspects, all reservations may be for the same number of sub-channels and the starting sub-channel may differ or not differ between reservations. FIG. 10 is a diagram 1000 illustrating example SCI reserving resources for multiple transmissions. As illustrated in FIG. 10, a first reservation by the SCI may reserve resources 1008 with two SCs. A second reservation by the SCI may reserve resources 1010 with two SCs. A third reservation by the SCI may reserve resources 1012 with two SCs. The first reservation may start at slot i, which may be 1. The second reservation may start at slot i+x, which may be 1+3. The third reservation may start at slot i+y, which may be 1+6. The number of SCs reserved may be z, which may equal to 2.

For SL-PRS transmissions, SL-PRS transmissions with periodic reservation and SL-PRS transmissions without periodic reservation may be supported. SL-PRS transmissions with periodic reservation may be SL-PRS transmissions that are being reserved based on SL periodic resource reservation. SL-PRS transmissions without periodic reservation may be SL-PRS transmissions in which the SL-PRS is transmitted at least once without periodic reservation. Aspects provided herein provide mechanisms for defining measurement periods for both SL-PRS transmissions with periodic reservation and SL-PRS transmissions without periodic reservation, facilitating sidelink positioning.

In some aspects, the measurement period for SL-PRS measurements reporting may be defined for each SL-PRS resource separately. For example, for each SL-PRS resource, the start time of the measurement period is the first slot after the SL-PRS resource is configured in the RP (or received in the assistance data) or (e.g., and/or) the first slot after an SCI scheduling the given SL-PRS resource is received.

In some aspects, the measurement period for SL-PRS measurements reporting may be defined for a group of SL-PRS resources that the UE is configured with. For example, the group of SL-PRS resources could correspond to all the SL-PRS resources that are: (1) configured in a same SL resource pool, (2) configured with a same message (such as a same SL-AssistanceDataMessage), (3) associated with a same positioning session ID, 4) associated with a same source ID or destination ID. In some aspects, for the group of SL-PRS resources, the start time of the measurement period is the first slot after (1) the configuration of the SL-PRS resource group is defined or (2) the configuration of the SL-PRS resource group is defined and the first SCI scheduling one of the SL-PRS resource(s) of the group is received.

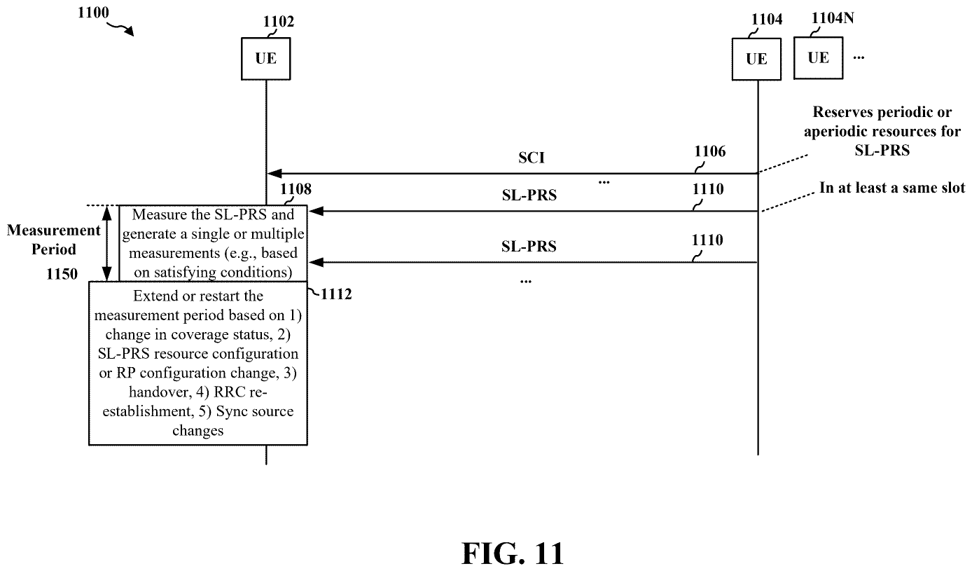

FIG. 11 is a diagram 1100 illustrating example communications between at least two UEs, UE 1102 and UE 1104. One or more additional UEs 1104N may also be involved. The UE 1104 and the one or more additional UEs 1104N may transmit a set of SCI 1106 to the UE 1102. The set of SCI 1106 may include SCI format 1-B for reserving resources for a set of SL-PRS 1110. In some aspects, the set of SCI 1106 may include SCI format 1-B for SL-PRS transmissions with periodic reservation or SL-PRS transmissions without periodic reservation. In some aspects, resources reserved for the set of SL-PRS 1110 may be periodic. In some aspects, resources reserved for the set of SL-PRS 1110 may be aperiodic.

In some aspects where the resources reserved for the set of SL-PRS 1110 is periodic, the number of samples (e.g., represented by Nₛₐₘₚₗₑ) to determine the measurement period of a single measurement may be 1 or more than 1. In some aspects where the number of samples (Nₛₐₘₚₗₑ) to determine the measurement period of a single measurement may be one, all the reserved resources that are signaled with one SCI are considered as part of 1 sample. In some of such aspects, the UE 802 may report a single measurement for all the reserved resources signaled with one SCI. In some aspects where the number of samples (Nₛₐₘₚₗₑ) to determine the measurement period of a single measurement may be more than one, each of the reserved resources that are signaled with one SCI are considered as one sample. In some of such aspects, the UE 802 may report a measurement for each of the reserved resources signaled with one SCI. In some aspects, if the number of samples to determine the measurement period of a single measurement is more than 1, the measurement period may apply under one or more conditions. The UE 802 may receive multiple SCIs in the set of SCI 1106 and each SCI may schedule a SL-PRS in the set of SL-PRS 1110 in at least a current slot (and may include additional reservations within a X-slot (e.g., X=32) window of the SCI), and may also include a non-zero resource reservation period (represented by Tᵣₑₛ) which may be based on the periodicity of that reservation. In some aspects, the one or more conditions may include a first condition that the SL-PRS resources that are scheduled across the multiple reservations (Nₛₐₘₚₗₑ>) (e.g., in each SCI) are scheduled with an SCI that includes the same periodicity

$$( {T}_{res}^{eff} = {T}_{res}^{1} = {T}_{res}^{2} = {T}_{res}^{{N}_{sample}} ) .$$

For example, the first SCI in the set of SCI 1106 schedules a first SL-PRS in the set of SL-PRS 1110 and includes a first Tᵣₑₛ, then the second SCI in the set of SCI 1106 may schedule a second SL-PRS in the set of SL-PRS 1110 that includes the same Tᵣₑₛ, except the last one, which may be 0 (which means no other periodic reservation is used). In some aspects, the one or more conditions may include a second condition that a same SL-PRS resource ID is being scheduled in all the Nₛₐₘₚₗₑ reservations (e.g., all of the SCIs in the set of SCI 1106 schedules a same SL-PRS resource ID). In some aspects, the one or more conditions may include a third condition that the same bandwidth is being scheduled in all the Nₛₐₘₚₗₑ reservations (e.g., all of the SCIs in the set of SCI 1106 schedules based on a same bandwidth). In some aspects, if the same bandwidth is not used, the smallest bandwidth across all the bandwidths may be used for accuracy determination. In some aspects, the one or more conditions may include a fourth condition that the Nₛₐₘₚₗₑ corresponds to the number of reservations that are done within a single period (e.g., all of the SCIs in the set of SCI 1106 schedules a same number of Nₛₐₘₚₗₑ in a single period). In some aspects, the one or more conditions may include a fifth condition the same number of SL-PRS symbols are used across the Nₛₐₘₚₗₑ reservations to derive a single measurement (e.g., all of the SCIs in the set of SCI 1106 schedules a same quantity of SL-PRS symbols to derive a single measurement). In some aspects, the one or more conditions may include a sixth condition that the same source-ID is used for the Nₛₐₘₚₗₑ reservations to derive a single measurement (e.g., all of the SCIs in the set of SCI 1106 indicates a same source ID for a single measurement). In some aspects, the one or more conditions may include a seventh condition the same destination-ID is used for the Nₛₐₘₚₗₑ reservations to derive a single measurement (e.g., all of the SCIs in the set of SCI 1106 indicates a same destination ID for a single measurement). In some aspects, the one or more conditions may include an eighth condition the same cast-type is used for the Nₛₐₘₚₗₑ reservations to derive a single measurement (e.g., all of the SCIs in the set of SCI 1106 indicates a same cast type out of multicast, broadcast, or unicast). The conditions described herein may be applied by standalone conditions or based on any combination of the conditions.

In some aspects, the UE 802 may measure the set of SL-PRS 1110 at 1108 and may generate a single measurement within a measurement period 1150 or multiple measurements (e.g., based on whether the set of SCI 1106 or the set of SL-PRS 1110 satisfies the conditions).

In some aspects where the resources reserved for the set of SL-PRS 1110 is aperiodic, the number of samples (Nₛₐₘₚₗₑ) to determine the measurement period of a single measurement may be one or more than one. In some aspects where the number of samples (Nₛₐₘₚₗₑ) to determine the measurement period of a single measurement may be one, all the reserved resources that are signaled with one SCI are considered as part of 1 sample.

In some aspects, at 1112, the measurement period may be extended, or may be restarted if one or more of the following conditions are satisfied: (1) a change in coverage status of the UE 802 (e.g., going between in-coverage, out-of-coverage, partial coverage) on the measurement period specifications and UE behaviour for SL positioning, (2) SL-PRS resource configuration or resource pool configuration of the UE 802 changes, (3) handover of the UE 802 occurs, (4) RRC re-establishment to a network entity occurs, (5) synchronization source of the UE 802 changes.

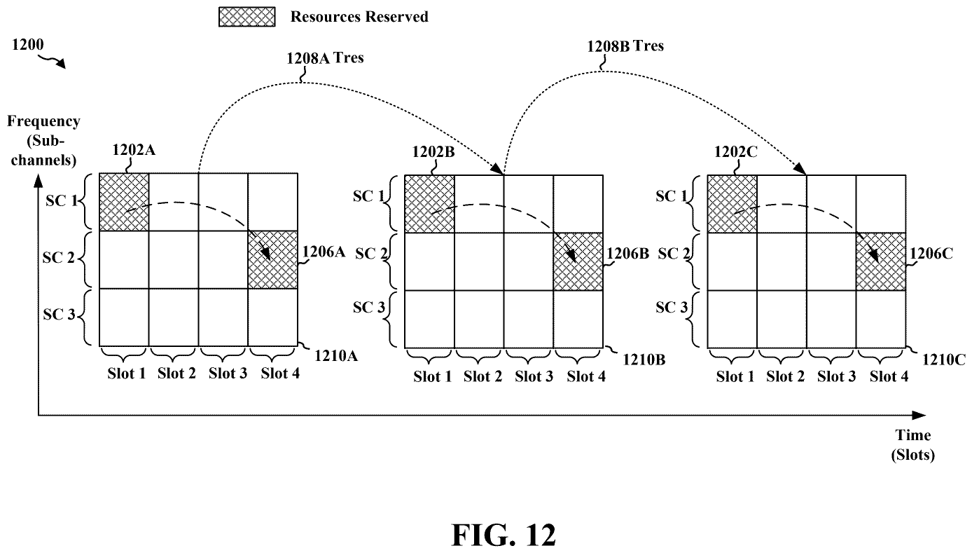

FIG. 12 is a diagram 1200 illustrating example SL-PRS and associated periodic reservations. As illustrated in FIG. 12, resources may be reserved for an initial transmission 1202A and a subsequent transmission 1206A in a first window. Resources may also be reserved for a first transmission 1202B and a subsequent transmission 1206B in a second window. Resources may also be reserved for a first transmission 1202C and a subsequent transmission 1206C in a third window. The periodicity may be the same and a first time 1208A between the reservations in a first instance 1210A and a second instance 1210B may equal to a second time 1208B between the reservations in the second instance 1210B and a third instance 1210C.

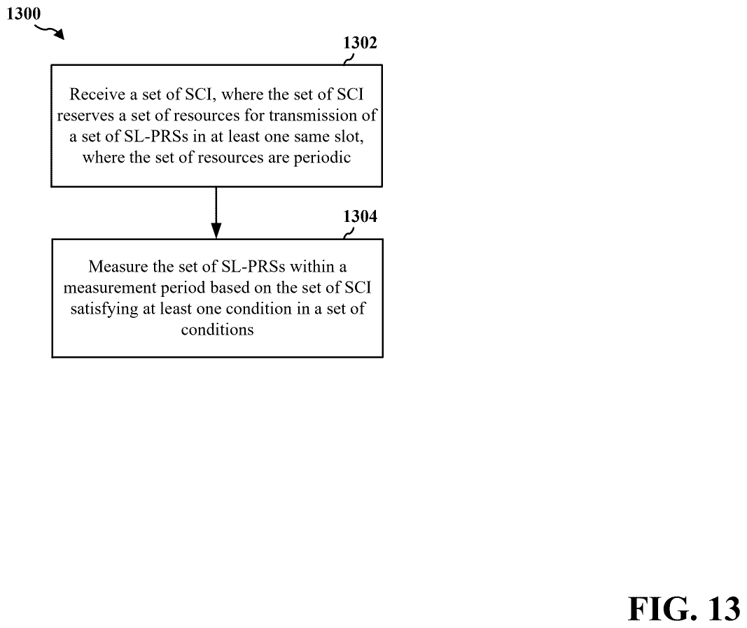

FIG. 13 is a flowchart 1300 of a method of wireless communication. The method may be performed by a UE (e.g., the UE 104, the UE 1102; the apparatus 1704).

At 1302, the UE may receive a set of SCI, where the set of SCI reserves a set of resources for transmission of a set of SL-PRSs in at least one same slot, where the set of resources are periodic. For example, the UE 1102 may receive a set of SCI (e.g., 1106), where the set of SCI reserves a set of resources for transmission of a set of SL-PRSs (e.g., 1110) in at least one same slot, where the set of resources are periodic. In some aspects, 1302 may be performed by positioning component 198.

At 1304, the UE may measure the set of SL-PRSs within a measurement period based on the set of SCI satisfying at least one condition in a set of conditions. For example, the UE 1102 may measure (e.g., at 1108) the set of SL-PRSs within a measurement period (e.g., 1150) based on the set of SCI satisfying at least one condition in a set of conditions. In some aspects, 1304 may be performed by positioning component 198.

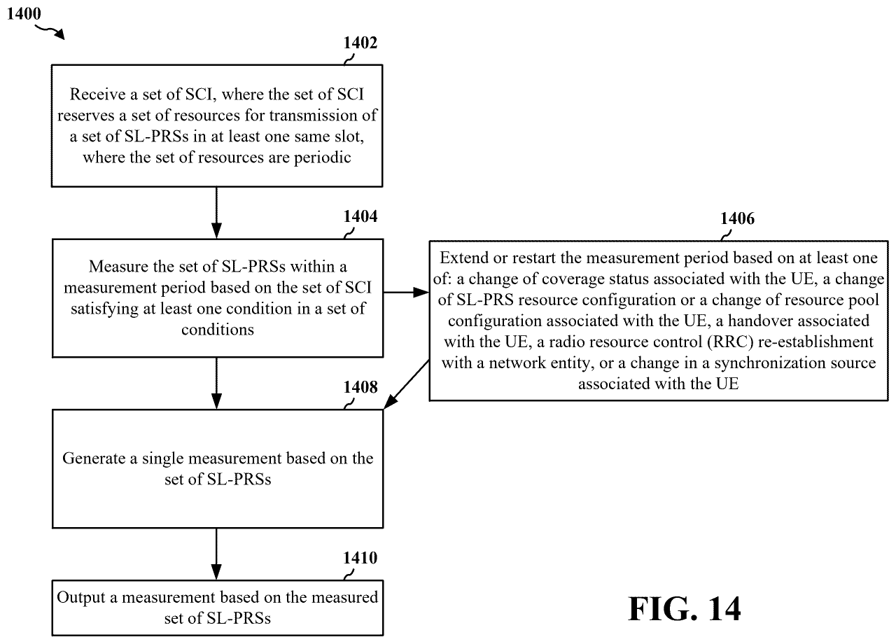

FIG. 14 is a flowchart 1400 of a method of wireless communication. The method may be performed by a UE (e.g., the UE 104, the UE 1102; the apparatus 1704).

At 1402, the UE may receive a set of SCI, where the set of SCI reserves a set of resources for transmission of a set of SL-PRSs in at least one same slot, where the set of resources are periodic. For example, the UE 1102 may receive a set of SCI (e.g., 1106), where the set of SCI reserves a set of resources for transmission of a set of SL-PRSs (e.g., 1110) in at least one same slot, where the set of resources are periodic. In some aspects, 1402 may be performed by positioning component 198.

At 1404, the UE may measure the set of SL-PRSs within a measurement period based on the set of SCI satisfying at least one condition in a set of conditions. For example, the UE 1102 may measure (e.g., at 1108) the set of SL-PRSs within a measurement period (e.g., 1150) based on the set of SCI satisfying at least one condition in a set of conditions. In some aspects, 1404 may be performed by positioning component 198. In some aspects, the measurement period is based on a quantity of multiple samples associated with the set of SCI. In some aspects, the set of conditions includes a condition that each resource in the set of resources is associated with a same periodicity. In some aspects, the set of conditions includes a condition that a same SL-PRS resource ID is associated with each SCI in the set of SCI. In some aspects, the set of conditions includes a condition that each SCI in the set of SCI is associated with a same bandwidth. In some aspects, the set of conditions includes a condition that each SCI in the set of SCI is associated with a respective bandwidth that includes a same bandwidth. In some aspects, the set of conditions includes a condition that the quantity of multiple samples is equal to a same quantity for each SCI in the set of SCI. In some aspects, the set of SL-PRSs is associated with a group of SL-PRS resources including the set of resources based on at least one of: a same sidelink resource pool associated with the set of SL-PRSs, a same sidelink assistance data message associated with the set of SL-PRSs, a same positioning session associated with the set of SL-PRSs, or a same destination or a same source associated with the set of SL-PRSs. In some aspects, a start time of the measurement period corresponds to a time after a configuration of set of SL-PRSs and after a first SCI schedules one SL-PRS in the group of SL-PRS resources. In some aspects, a start time of the measurement period corresponds to a time after a configuration of set of SL-PRSs.

At 1406, the UE may extend or restart the measurement period based on at least one of: a change of coverage status associated with the UE, a change of SL-PRS resource configuration or a change of resource pool configuration associated with the UE, a handover associated with the UE, a radio resource control (RRC) re-establishment with a network entity, or a change in a synchronization source associated with the UE. For example, the UE 1102 may extend or restart the measurement period based on at least one of: a change of coverage status associated with the UE, a change of SL-PRS resource configuration or a change of resource pool configuration associated with the UE, a handover associated with the UE, a radio resource control (RRC) re-establishment with a network entity, or a change in a synchronization source associated with the UE. In some aspects, 1406 may be performed by positioning component 198.

In some aspects, to measure the set of SL-PRSs within the measurement period, at 1408, the UE may generate a single measurement based on the set of SL-PRSs. For example, the UE 1102 may generate (e.g., at 1108) a single measurement based on the set of SL-PRSs. In some aspects, 1408 may be performed by positioning component 198. In some aspects, the UE may generate a single measurement based on the set of SL-PRSs, where the set of conditions includes a condition that each SL-PRS of the set of SL-PRSs is associated with a same quantity of symbols. In some aspects, the UE may generate a single measurement based on the set of SL-PRSs, where the set of conditions includes a condition that each SL-PRS of the set of SL-PRSs is associated with a same source. In some aspects, the UE may generate a single measurement based on the set of SL-PRSs, where the set of conditions includes a condition that each SL-PRS of the set of SL-PRSs is associated with a same destination. In some aspects, the UE may generate a single measurement based on the set of SL-PRSs, where the set of conditions includes a condition that each SL-PRS of the set of SL-PRSs is associated with a same cast type (e.g., broadcast, multicast, or unicast).

At 1410, the UE may output a measurement based on the measured set of SL-PRSs. For example, the UE 1102 may output a measurement based on the measured set of SL-PRSs. In some aspects, 1410 may be performed by positioning component 198. To output a measurement based on the measured set of SL-PRSs, the UE may transmit the measurement based on the measured set of SL-PRSs or store the measurement based on the measured set of SL-PRSs.

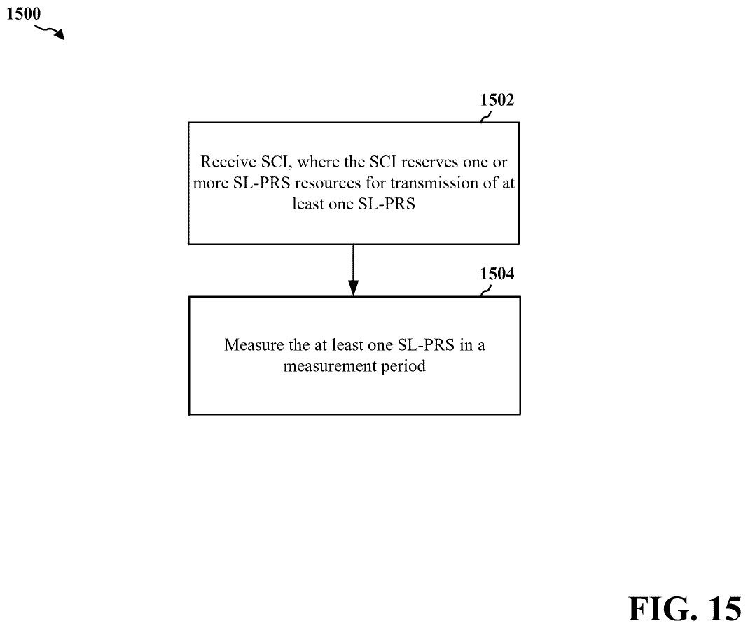

FIG. 15 is a flowchart 1500 of a method of wireless communication. The method may be performed by a UE (e.g., the UE 104, the UE 1102; the apparatus 1704).

At 1502, the UE may receive SCI, where the SCI reserves one or more SL-PRS resources for transmission of at least one SL-PRS. For example, the UE 1102 may receive SCI (e.g., 1106), where the SCI reserves one or more SL-PRS resources for transmission of at least one SL-PRS (e.g., 1110). In some aspects, 1502 may be performed by positioning component 198.

At 1504, the UE may measure the at least one SL-PRS in a measurement period. For example, the UE 1102 may measure (e.g., at 1108) the at least one SL-PRS in a measurement period (e.g., 1150). In some aspects, 1504 may be performed by positioning component 198. In some aspects, the measurement period is based on a quantity of SL-PRS resources associated with the measurement period.

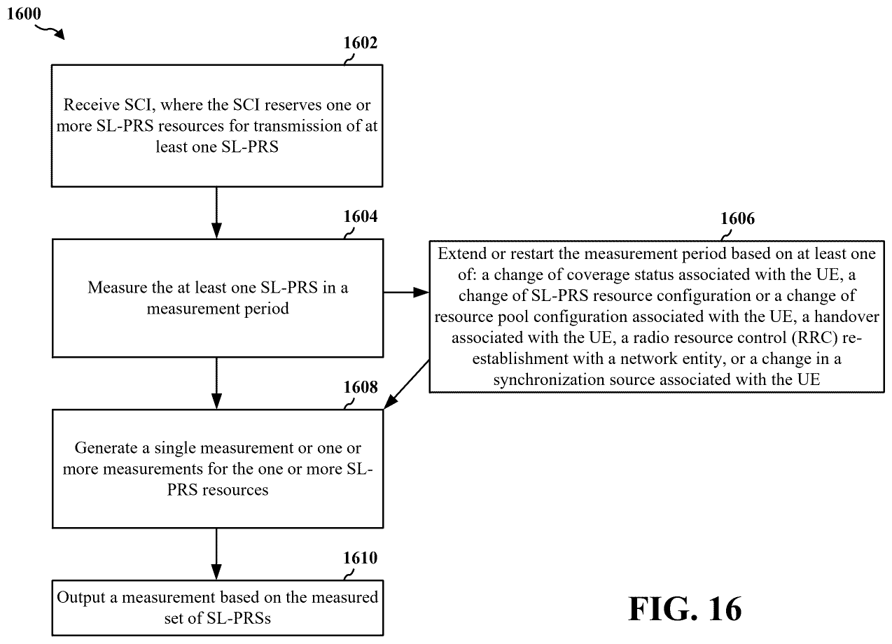

FIG. 16 is a flowchart 1600 of a method of wireless communication. The method may be performed by a UE (e.g., the UE 104, the UE 1102; the apparatus 1704).

At 1602, the UE may receive SCI, where the SCI reserves one or more SL-PRS resources for transmission of at least one SL-PRS. For example, the UE 1102 may receive SCI (e.g., 1106), where the SCI reserves one or more SL-PRS resources for transmission of at least one SL-PRS (e.g., 1110). In some aspects, 1602 may be performed by positioning component 198.

At 1604, the UE may measure the at least one SL-PRS in a measurement period. For example, the UE 1102 may measure (e.g., at 1108) the at least one SL-PRS in a measurement period (e.g., 1150). In some aspects, 1604 may be performed by positioning component 198. In some aspects, the measurement period is based on a quantity of SL-PRS resources associated with the measurement period.

At 1606, the UE may extend or restart the measurement period based on at least one of: a change of coverage status associated with the UE, a change of SL-PRS resource configuration or a change of resource pool configuration associated with the UE, a handover associated with the UE, a radio resource control (RRC) re-establishment with a network entity, or a change in a synchronization source associated with the UE. For example, the UE 1102 may extend or restart the measurement period based on at least one of: a change of coverage status associated with the UE, a change of SL-PRS resource configuration or a change of resource pool configuration associated with the UE, a handover associated with the UE, a radio resource control (RRC) re-establishment with a network entity, or a change in a synchronization source associated with the UE. In some aspects, 1606 may be performed by positioning component 198.

At 1608, the UE may generate a single measurement for the one or more SL-PRS resources or generate one or more measurements for the one or more SL-PRS resources. For example, the UE 1102 may generate a single measurement for the one or more SL-PRS resources or generate one or more measurements for the one or more SL-PRS resources (e.g., at 1108). In some aspects, 1608 may be performed by positioning component 198.

At 1610, the UE may output a measurement based on the measured at least one SL-PRS. For example, the UE 1102 may output a measurement based on the measured at least one SL-PRS. In some aspects, 1610 may be performed by positioning component 198. In some aspects, to output the indication, the UE may transmit the measurement based on the measured at least one SL-PRS or store the measurement based on the measured at least one SL-PRS.

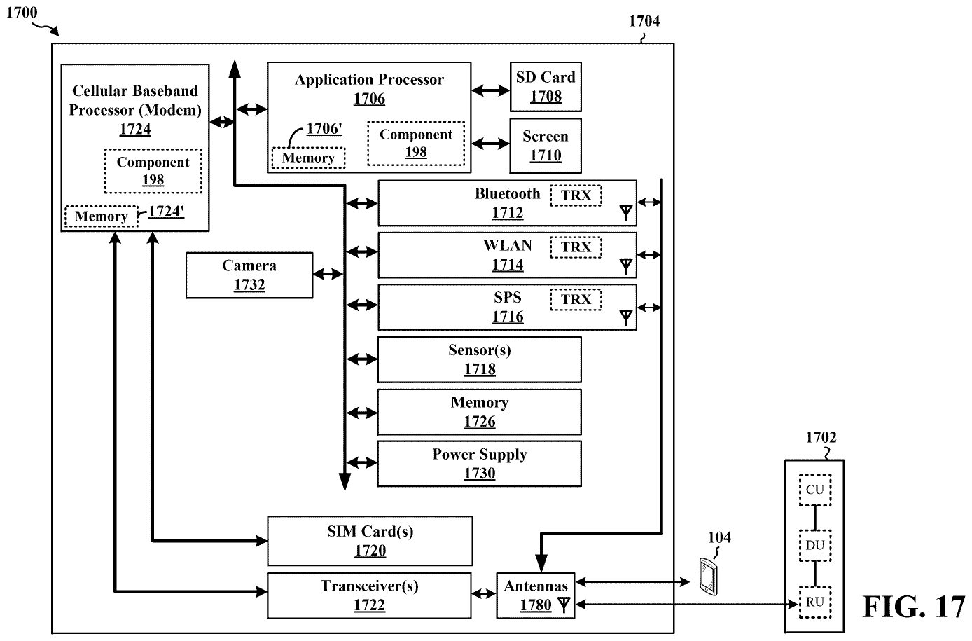

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include at least one cellular baseband processor 1724 (also referred to as a modem) coupled to one or more transceivers 1722 (e.g., cellular RF transceiver). The cellular baseband processor(s) 1724 may include at least one on-chip memory 1724′. In some aspects, the apparatus 1704 may further include one or more subscriber identity modules (SIM) cards 1720 and at least one application processor 1706 coupled to a secure digital (SD) card 1708 and a screen 1710. The application processor(s) 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor(s) 1724 communicates through the transceiver(s) 1722 via one or more antennas 1780 with the UE 104 and/or with an RU associated with a network entity 1702. The cellular baseband processor(s) 1724 and the application processor(s) 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor(s) 1724 and the application processor(s) 1706 are each responsible for general processing, including the execution of software stored on the computer-readable medium/memory. The software, when executed by the cellular baseband processor(s) 1724/application processor(s) 1706, causes the cellular baseband processor(s) 1724/application processor(s) 1706 to perform the various functions described supra. The computer-readable medium/memory may also be used for storing data that is manipulated by the cellular baseband processor(s) 1724/application processor(s) 1706 when executing software. The cellular baseband processor(s) 1724/application processor(s) 1706 may be a component of the device 350 and may include the at least one memory 360 and/or at least one of the TX processor 368, the RX processor 356, and the controller/processor 359. In one configuration, the apparatus 1704 may be at least one processor chip (modem and/or application) and include just the cellular baseband processor(s) 1724 and/or the application processor(s) 1706, and in another configuration, the apparatus 1704 may be the entire UE (e.g., see device 350 of FIG. 3) and include the additional modules of the apparatus 1704.

As discussed supra, the positioning component 198 may be configured to receive a set of sidelink control information (SCI), where the set of SCI reserves a set of resources for transmission of a set of sidelink positioning reference signals (SL-PRSs) in at least one same slot, where the set of resources are periodic. In some aspects, the positioning component 198 may be further configured to measure the set of SL-PRSs within a measurement period based on the set of SCI satisfying at least one condition in a set of conditions. In some aspects, the positioning component 198 may be further configured to receive sidelink control information (SCI), where the SCI reserves one or more SL-PRS resources for transmission of at least one sidelink positioning reference signal (SL-PRS). In some aspects, the positioning component 198 may be further configured to measure the at least one SL-PRS in a measurement period. The positioning component 198 may be within the cellular baseband processor(s) 1724, the application processor(s) 1706, or both the cellular baseband processor(s) 1724 and the application processor(s) 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1704 may include a variety of components configured for various functions. In one configuration, the apparatus 1704, and in particular the cellular baseband processor(s) 1724 and/or the application processor(s) 1706, may include means for receiving a set of SCI, where the set of SCI reserves a set of resources for transmission of a set of SL-PRSs in at least one same slot, where the set of resources are periodic. In some aspects, the apparatus 1704 may include means for measuring the set of SL-PRSs within a measurement period based on the set of SCI satisfying at least one condition in a set of conditions. In some aspects, the apparatus 1704 may include means for receiving SCI, where the SCI reserves one or more SL-PRS resources for transmission of at least one SL-PRS. In some aspects, the apparatus 1704 may include means for measuring the at least one SL-PRS in a measurement period. In some aspects, the apparatus 1704 may include means for outputting a measurement based on the measured set of SL-PRSs. In some aspects, the apparatus 1704 may include means for transmitting the measurement based on the measured set of SL-PRSs. In some aspects, the apparatus 1704 may include means for storing the measurement based on the measured set of SL-PRSs. In some aspects, the apparatus 1704 may include means for generating a single measurement based on the set of SL-PRSs, where the set of conditions includes a condition that each SL-PRS of the set of SL-PRSs is associated with a same quantity of symbols. In some aspects, the apparatus 1704 may include means for generating a single measurement based on the set of SL-PRSs, where the set of conditions includes a condition that each SL-PRS of the set of SL-PRSs is associated with a same source. In some aspects, the apparatus 1704 may include means for generating a single measurement based on the set of SL-PRSs, where the set of conditions includes a condition that each SL-PRS of the set of SL-PRSs is associated with a same destination. In some aspects, the apparatus 1704 may include means for generating a single measurement based on the set of SL-PRSs, where the set of conditions includes a condition that each SL-PRS of the set of SL-PRSs is associated with a same cast type. In some aspects, the apparatus 1704 may include means for extending or restarting the measurement period based on at least one of: a change of coverage status associated with the UE, a change of SL-PRS resource configuration or a change of resource pool configuration associated with the LE, a handover associated with the UE, a radio resource control (RRC) re-establishment with a network entity, or a change in a synchronization source associated with the UE. In some aspects, the apparatus 1704 may include means for outputting a measurement based on the measured at least one SL-PRS. In some aspects, the apparatus 1704 may include means for transmitting the measurement based on the measured at least one SL-PRS. In some aspects, the apparatus 1704 may include means for storing the measurement based on the measured at least one SL-PRS. In some aspects, the apparatus 1704 may include means for generating a single measurement for the one or more SL-PRS resources. In some aspects, the apparatus 1704 may include means for generating one or more measurements for the one or more SL-PRS resources. The means may be the component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method for wireless communication performed by a user equipment (UE), including: receiving a set of sidelink control information (SCI), where the set of SCI reserves a set of resources for transmission of a set of sidelink positioning reference signals (SL-PRSs) in at least one same slot, where the set of resources are periodic; and measuring the set of SL-PRSs within a measurement period based on the set of SCI satisfying at least one condition in a set of conditions.

Aspect 2 is the method of aspect 1, where further including: output a measurement based on the measured set of SL-PRSs.

Aspect 3 is the method of aspect 2, where to output the measurement based on the measured set of SL-PRSs, further including: transmitting the measurement based on the measured set of SL-PRSs; or storing the measurement based on the measured set of SL-PRSs.

Aspect 4 is the method of any of aspects 1-3, where the measurement period is based on a quantity of multiple samples associated with the set of SCI.

Aspect 5 is the method of aspect 4, where the set of conditions includes a condition that each resource in the set of resources is associated with a same periodicity.

Aspect 6 is the method of any of aspects 4-5, where the set of conditions includes a condition that a same SL-PRS resource identifier (ID) is associated with each SCI in the set of SCI.

Aspect 7 is the method of any of aspects 4-6, where the set of conditions includes a condition that each SCI in the set of SCI is associated with a same bandwidth.

Aspect 8 is the method of any of aspects 4-7, where the set of conditions includes a condition that each SCI in the set of SCI is associated with a respective bandwidth that includes a same bandwidth.

Aspect 9 is the method of any of aspects 4-8, where the set of conditions includes a condition that the quantity of multiple samples is equal to a same quantity for each SCI in the set of SCI.

Aspect 10 is the method of any of aspects 4-9, where to measuring the set of SL-PRSs within the measurement period, further including: generating a single measurement based on the set of SL-PRSs, where the set of conditions includes a condition that each SL-PRS of the set of SL-PRSs is associated with a same quantity of symbols.

Aspect 11 is the method of any of aspects 4-10, where to measuring the set of SL-PRSs within the measurement period, further including: generating a single measurement based on the set of SL-PRSs, where the set of conditions includes a condition that each SL-PRS of the set of SL-PRSs is associated with a same source.

Aspect 12 is the method of any of aspects 4-11, where to measuring the set of SL-PRSs within the measurement period, further including: generating a single measurement based on the set of SL-PRSs, where the set of conditions includes a condition that each SL-PRS of the set of SL-PRSs is associated with a same destination.

Aspect 13 is the method of any of aspects 4-12, where to measuring the set of SL-PRSs within the measurement period, further including: generating a single measurement based on the set of SL-PRSs, where the set of conditions includes a condition that each SL-PRS of the set of SL-PRSs is associated with a same cast type.

Aspect 14 is the method of any of aspects 1-13, where the set of SL-PRSs is associated with a group of SL-PRS resources including the set of resources based on at least one of: a same sidelink resource pool associated with the set of SL-PRSs, a same sidelink assistance data message associated with the set of SL-PRSs, a same positioning session associated with the set of SL-PRSs, or a same destination or a same source associated with the set of SL-PRSs.

Aspect 15 is the method of aspect 14, where a start time of the measurement period corresponds to a time after a configuration of set of SL-PRSs and after a first SCI schedules one SL-PRS in the group of SL-PRS resources.

Aspect 16 is the method of any of aspects 1-14, where a start time of the measurement period corresponds to a time after a configuration of set of SL-PRSs.

Aspect 17 is the method of any of aspects 1-16, where further including: extending or restarting the measurement period based on at least one of: a change of coverage status associated with the UE, a change of SL-PRS resource configuration or a change of resource pool configuration associated with the UE, a handover associated with the UE, a radio resource control (RRC) re-establishment with a network entity, or a change in a synchronization source associated with the UE.

Aspect 18 is the method of any of aspects 1-17, further including receiving the set of SCI via at least one of the transceiver or the antenna.

Aspect 19 is a method for wireless communication performed by a user equipment (UE), including: receiving sidelink control information (SCI), where the SCI reserves one or more SL-PRS resources for transmission of at least one sidelink positioning reference signal (SL-PRS); and measuring the at least one SL-PRS in a measurement period.

Aspect 20 is the method of aspect 19, where further including: outputting a measurement based on the measured at least one SL-PRS.

Aspect 21 is the method of aspect 20, where to output the measurement based on the measurement based on the measured at least one SL-PRS, further including: transmitting the measurement based on the measured at least one SL-PRS; or storing the measurement based on the measured at least one SL-PRS.

Aspect 22 is the method of any of aspects 19-21, where the measurement period is based on a quantity of SCI associated with the measurement period, and where measuring the at least one SL-PRS further includes: generating a single measurement for the one or more SL-PRS resources.

Aspect 23 is the method of any of aspects 19-22, where the measurement period is based on a quantity of SL-PRS resources associated with the measurement period, and where measuring the at least one SL-PRS further includes: generating one or more measurements for the one or more SL-PRS resources.

Aspect 24 is the method of any of aspects 19-23, where further including: extending or restarting the measurement period based on at least one of: a change of coverage status associated with the UE, a change of SL-PRS resource configuration or a change of resource pool configuration associated with the UE, a handover associated with the UE, a radio resource control (RRC) re-establishment with a network entity, or a change in a synchronization source associated with the UE.

Aspect 25 is the method of aspect 19, further including receiving the SCI via at least one of the transceiver or the antenna.

Aspect 26 is an apparatus for wireless communication at a device, such as a UE, including at least one memory and at least one processor coupled to the at least one memory and, based at least in part on information stored in the at least one memory, the at least one processor is configured, individually or in combination, to implement any of aspects 1 to 25.

Aspect 27 is the apparatus of aspect 26, further including one or more transceivers or one or more antennas coupled to the at least one processor.

Aspect 28 is an apparatus for wireless communication at a device including means for implementing any of aspects 1 to 25.

Aspect 29 is a computer-readable medium (e.g., a non-transitory computer-readable medium) storing computer executable code, where the code when executed by at least one processor causes the at least one processor to implement any of aspects 1 to 25.

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive a set of sidelink control information (SCI), wherein the set of SCI reserves a set of resources for transmission of a set of sidelink positioning reference signals (SL-PRSs) in at least one same slot, wherein the set of resources are periodic; and
measure the set of SL-PRSs within a measurement period based on the set of SCI satisfying at least one condition in a set of conditions.

2. The apparatus of claim 1, wherein the at least one processor, individually or in any combination, is further configured to:
output a measurement based on the measured set of SL-PRSs.

3. The apparatus of claim 2, wherein to output the measurement based on the measured set of SL-PRSs, the at least one processor, individually or in any combination, is configured to:
transmit the measurement based on the measured set of SL-PRSs; or
store the measurement based on the measured set of SL-PRSs.

4. The apparatus of claim 1, wherein the measurement period is based on a quantity of multiple samples associated with the set of SCI.

5. The apparatus of claim 4, wherein the set of conditions comprises a condition that each resource in the set of resources is associated with a same periodicity.

6. The apparatus of claim 4, wherein the set of conditions comprises a condition that a same SL-PRS resource identifier (ID) is associated with each SCI in the set of SCI.

7. The apparatus of claim 4, wherein the set of conditions comprises a condition that each SCI in the set of SCI is associated with a same bandwidth.

8. The apparatus of claim 4, wherein the set of conditions comprises a condition that each SCI in the set of SCI is associated with a respective bandwidth that includes a same bandwidth.

9. The apparatus of claim 4, wherein the set of conditions comprises a condition that the quantity of multiple samples is equal to a same quantity for each SCI in the set of SCI.

10. The apparatus of claim 4, wherein to measure the set of SL-PRSs within the measurement period, the at least one processor, individually or in any combination, is configured to:
generate a single measurement based on the set of SL-PRSs, wherein the set of conditions comprises a condition that each SL-PRS of the set of SL-PRSs is associated with a same quantity of symbols.

11. The apparatus of claim 4, wherein to measure the set of SL-PRSs within the measurement period, the at least one processor, individually or in any combination, is configured to:
generate a single measurement based on the set of SL-PRSs, wherein the set of conditions comprises a condition that each SL-PRS of the set of SL-PRSs is associated with a same source.

12. The apparatus of claim 4, wherein to measure the set of SL-PRSs within the measurement period, the at least one processor, individually or in any combination, is configured to:
generate a single measurement based on the set of SL-PRSs, wherein the set of conditions comprises a condition that each SL-PRS of the set of SL-PRSs is associated with a same destination.

13. The apparatus of claim 4, wherein to measure the set of SL-PRSs within the measurement period, the at least one processor, individually or in any combination, is configured to:
generate a single measurement based on the set of SL-PRSs, wherein the set of conditions comprises a condition that each SL-PRS of the set of SL-PRSs is associated with a same cast type.

14. The apparatus of claim 1, wherein the set of SL-PRSs is associated with a group of SL-PRS resources including the set of resources based on at least one of: a same sidelink resource pool associated with the set of SL-PRSs, a same sidelink assistance data message associated with the set of SL-PRSs, a same positioning session associated with the set of SL-PRSs, or a same destination or a same source associated with the set of SL-PRSs.

15. The apparatus of claim 14, wherein a start time of the measurement period corresponds to a time after a configuration of set of SL-PRSs and after a first SCI schedules one SL-PRS in the group of SL-PRS resources.

16. The apparatus of claim 1, wherein a start time of the measurement period corresponds to a time after a configuration of set of SL-PRSs.

17. The apparatus of claim 1, wherein the at least one processor, individually or in any combination, is further configured to:
extend or restart the measurement period based on at least one of: a change of coverage status associated with the UE, a change of SL-PRS resource configuration or a change of resource pool configuration associated with the UE, a handover associated with the UE, a radio resource control (RRC) re-establishment with a network entity, or a change in a synchronization source associated with the UE.

18. The apparatus of claim 1, further comprising at least one of a transceiver or an antenna coupled to the at least one processor, wherein to receive the set of SCI, the at least one processor, individually or in any combination, is configured to receive the set of SCI via at least one of the transceiver or the antenna.

19. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive sidelink control information (SCI), wherein the SCI reserves one or more SL-PRS resources for transmission of at least one sidelink positioning reference signal (SL-PRS); and
measure the at least one SL-PRS in a measurement period.

20-25. (canceled)

26. A method for wireless communication performed by a user equipment (UE), comprising:
receiving a set of sidelink control information (SCI), wherein the set of SCI reserves a set of resources for transmission of a set of sidelink positioning reference signals (SL-PRSs) in at least one same slot, wherein the set of resources are periodic; and
measuring the set of SL-PRSs within a measurement period based on the set of SCI satisfying at least one condition in a set of conditions.

27-30. (canceled)
